(19) United States
(12) Patent Application Publication
(10) Pub. No.: US 2023/0262781 A1
(43) Pub. Date: Aug. 17, 2023

(54) SYSTEM AND METHODS OF RANDOM ACCESS CHANNEL (RACH) OPTIMIZATION

(71) Applicant: ZTE Corporation, Shenzhen (CN)

(72) Inventors: Jianmin FANG, Shenzhen (CN); Zhihong QIU, Shenzhen (CN); He HUANG, Shenzhen (CN)

(21) Appl. No.: 18/137,302

(22) Filed: Apr. 20, 2023

Related U.S. Application Data
(63) Continuation of application No. PCT/CN2020/122358, filed on Oct. 21, 2020.

(51) Int. Cl. H04W 74/08

(52) U.S. Cl. CPC H04W 74/0833

(57) ABSTRACT

A method for wireless communications includes receiving, by a network node, a message from a wireless device, wherein the message includes information of a random access (RA) procedure between the wireless device and the network node; and using, by the network node, the information of the RA procedure for random access channel (RACH) optimization.

### CROSS-REFERENCE TO RELATED APPLICATIONS

This application is a continuation of International Patent Application No. PCT/CN2020/122358, filed on Oct. 21, 2020, the contents of which are incorporated herein by reference in their entirety.

### TECHNICAL FIELD

This patent document is directed generally to wireless communications.

### BACKGROUND

With the advent of the era of Internet of things, large numbers of different mobile devices will access the network at the same time. This will be a great challenge for allocation of random access (RA) resources among these different mobile devices. Accordingly, there is a need to optimize performance of the network and the user equipment (UE) so that resources can be more effectively allocated.

### SUMMARY

In one exemplary embodiment, a method for wireless communications includes receiving, by a network node, a message from a wireless device, wherein the message includes information of a random access (RA) procedure between the wireless device and the network node; and using, by the network node, the information of the RA procedure for random access channel (RACH) optimization.

### BRIEF DESCRIPTION OF THE DRAWINGS

FIG. 1A illustrates an example 5G network architecture.

FIG. 1B to FIG. 1E show examples of various random access (RA) procedures.

FIG. 2 is a signaling process for an example embodiment.

FIG. 3 is a signaling process for an example embodiment.

FIG. 4 shows an example of a wireless communication system where techniques in accordance with one or more embodiments of the present technology can be applied.

FIG. 5 is a block diagram representation of a portion of a hardware platform.

FIG. 6 illustrates a flowchart of an example method associated with RACH optimization.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

The development of the new generation of wireless communication—5G New Radio (NR) communication—is a part of a continuous mobile broadband evolution process to meet the requirements of increasing network demand. NR will provide greater throughput to allow more users connected at the same time. Other aspects, such as energy consumption, device cost, spectral efficiency, and latency are also important to meeting the needs of various communication scenarios.

### Overview

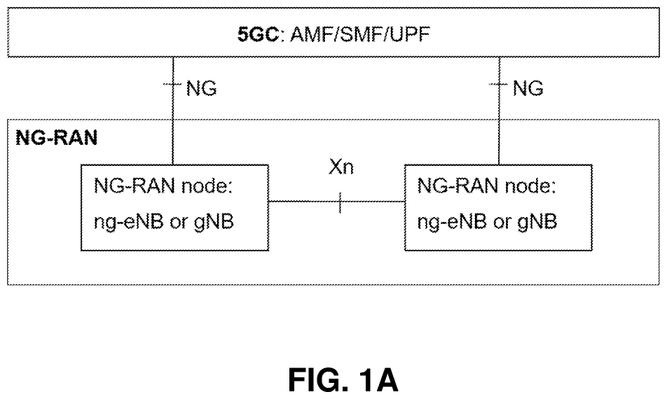

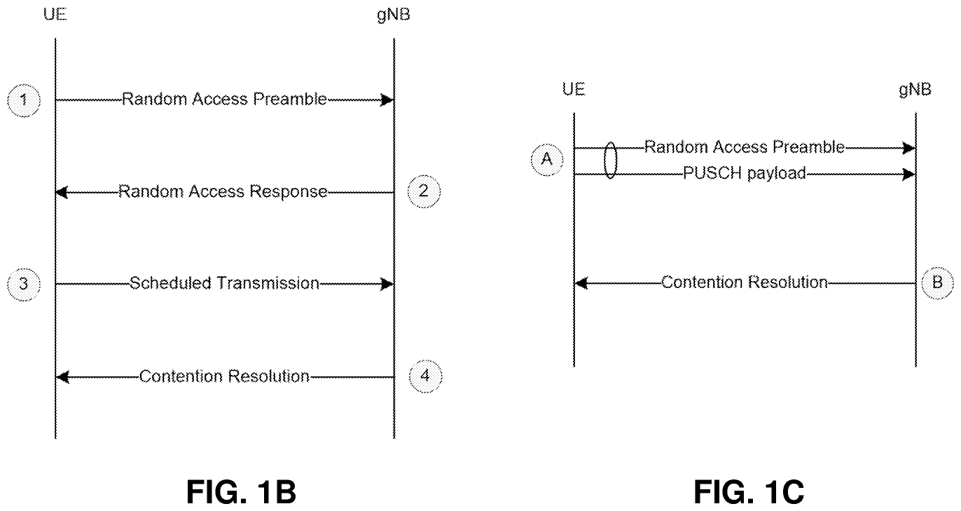

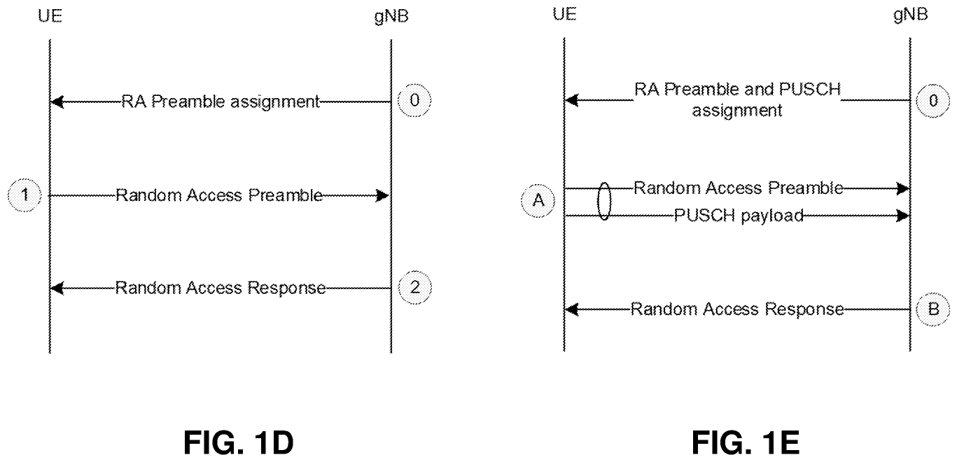

FIG. 1A illustrates an example 5G network architecture. For example, a 5G network architecture may include a 5G core network (5GC) and a next generation radio access network (NG-RAN). The 5GC may include any of an Access Mobility Function (AMF), a Session Management Function (SMF), and a User Plane Function (UPF). The NG-RAN may include base stations with different radio access technologies (RATs), such as an evolved 4G base station (ng-eNB), a 5G base station (gNB). The NG-RAN base station may be connected to the 5GC through the NG interface, and the NG-RAN base stations may be connected through the Xn interface. A RAN node can be a gNB (5G base station) providing New Radio (NR) user plane and control plane services. As another example, a RAN node can be an enhanced 4G eNodeB that connects to the 5G Core network via the NG interfaces but still uses 4G LTE air interface(s) to communicate with the 5G UE/wireless device.

FIG. 1B to FIG. 1E show examples of various random access (RA) procedures. For example, FIG. 1B depicts a contention based random access (CBRA) with a 4-step RA procedure. FIG. 1C depicts a CBRA with a 2-step RA procedure. FIG. 1D depicts a contention free random access (CFRA) with a 4-step RA procedure. FIG. 1E depicts a CFRA with a 2-step RA procedure. In connection with FIGS. 1B to 1E, the following nomenclatures are used:

MSG1: preamble transmission of the 4-step random access (RA) procedure.

MSG2: response to MSG1

MSG3: first scheduled transmission of the 4-step RA procedure.

MSG4: response to MSG3

MSGA: preamble and payload transmissions of the 2-step RA type procedure

MSGB: response to MSGA in the 2-step random access procedure.

MSGB may include response(s) for contention resolution, fallback indication(s), and back off indication.

A RA procedure may include multiple RA attempts. A successful RA procedure is one in which the final attempt is successful. On the other hand, an unsuccessful RA procedure means that all the attempts have failed.

A RA procedure can be triggered by a number of events. Examples include: an initial access from RRC_IDLE, a RRC Connection Re-establishment procedure, a DL or UL data arrival during RRC_CONNECTED when UL synchronisation status is “non-synchronised,” a UL data arrival during RRC_CONNECTED when there are no PUCCH resources for SR available, a SR failure, a Request by RRC upon synchronous reconfiguration (e.g., handover), a transition from RRC_INACTIVE, establishing a time alignment for a secondary TAG, a request for Other system information, a beam failure recovery, or a consistent UL LBT failure on SpCell.

The RRC can support the following states: RRC_IDLE, RRC_INACTIVE, and RRC_CONNECTED. Examples of details associated with these states are provided as follows.

RRC_IDLE:
PLMN selection;
Broadcast of system information;
Cell re-selection mobility;
Paging for mobile terminated data is initiated by 5GC;
DRX for CN paging configured by NAS.

RRC_INACTIVE:
PLMN selection;
Broadcast of system information;
Cell re-selection mobility;
Paging is initiated by NG-RAN (RAN paging);
RAN-based notification area (RNA) is managed by NG-RAN;
DRX for RAN paging configured by NG-RAN;
5GC—NG-RAN connection (both C/U-planes) is established for UE;
The UE AS context is stored in NG-RAN and the UE;
NG-RAN knows the RNA which the UE belongs to.

RRC_CONNECTED:
5GC—NG-RAN connection (both C/U-planes) is established for UE;
The UE AS context is stored in NG-RAN and the UE;
NG-RAN knows the cell which the UE belongs to;
Transfer of unicast data to/from the UE;
Network controlled mobility including measurements.

### EXAMPLE EMBODIMENTS

Embodiments of the present technology are directed at a network node (also termed herein as “network node,” “NW,” or “node”) using random access (RA) reporting information related to RA resources associated with a UE (also termed herein as “wireless device”) to perform network performance optimization. For example, by using the disclosed technology, a network can adjust one or more parameters to allocate the RA resources effectively for a future RA procedure. In some embodiments, the disclosed methods can reduce unsuccessful RA attempts by a wireless device. For example, this can help in reducing the rate of unsuccessful RA attempts to the total (cumulative) number of RA attempts by the wireless device. In some embodiments, the disclosed methods allow RA resources to be shared by multiple RA procedures, thereby increasing the usage efficiency of the RA resources. In some embodiments, by employing efficient signaling techniques, the disclosed methods facilitate reduced the signaling of different types of RA information (e.g., successful RA procedure, unsuccessful RA procedure information, failure information and the like) from wireless devices. For example, depending on whether a certain condition is satisfied, the disclosed methods discuss signaling of RA information selectively, which results in reduced signaling overhead. Further, the disclosed technology improves the success rate of RA procedures by balancing between a success rate and promptness, and a result facilitates better resource allocation for RA procedures.

### Example Embodiment 1 (RA Information)

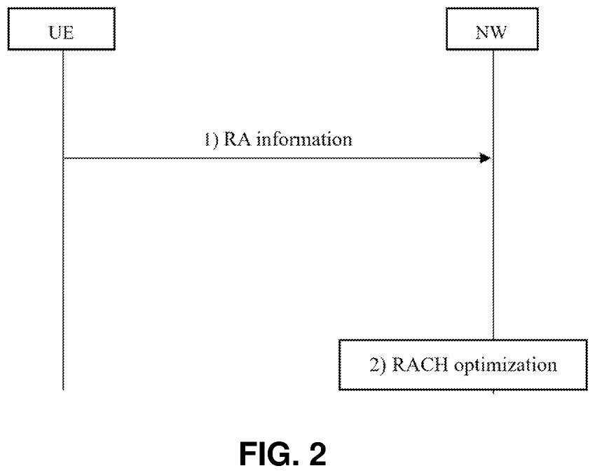

FIG. 2 is a signaling process for this example embodiment.

Step 1: A UE sends a RA information to a network node. The RA information includes can relate to a successful or unsuccessful RA procedure. The RA information includes at least one of:
An indication of whether multiple RA resource types are configured. (For example, the indication can be used to indicate whether both 4 step RA and 2 step RA resource are configured for a RA procedure),
A maximum number of Msg A transmission allowed in an usual or regular RA procedure (e.g. MsgA-TransMax),
An indication of whether a maximum number of MsgA transmission is reached or exceeded,
A threshold used for uplink carrier selection (e.g. rsrp-ThresholdSSB-SUL, for selection between normal uplink (NUL) and supplementary uplink (SUL)),
An Indication of whether the strength or quality of selected beam is > (higher), >= (higher or equal), < (lower) or <= (lower or equal) than the threshold configured for uplink carrier selection. As an example, for a selection between NUL and SUL, this indication can be set per RA attempt or per RA procedure.
An indication of whether the strength or quality of downlink pathloss reference is > (higher) or >= (higher or equal) than the threshold configured by the network for RA type selection.
An indication of whether the strength or quality of selected beam is > (higher) or >= (higher or equal) than the threshold configured by the network for RA type selection.
An indication of whether MsgA PUSCH payload is transmitted for a 2-step RA attempt.
An indication of whether the whole RACH occasion (RO) can be used for a 2-step RA procedure when the RO resource is shared between a 4-step RA procedure and a 2-step RA procedure.
An indication of whether MsgB is received or not (e.g., the indication can be set to false if MsgB response window expires, otherwise it is set to true).
A PUSCH (Physical Uplink Shared Channel) configuration information of the PUSCH resource used in the RA procedure, which includes at least one of the following:
   The number of msgA PUSCH occasions FDMed in one time instance, e.g. nrofMsgA-PO-FDM
   Offset of lowest PUSCH occasion in frequency domain with respect to PRB 0, e.g. frequencyStartMsgA-PUSCH
   SCS of the PUSCH resource used for MsgA PUSCH payload transmission
   The MCS index used for msgA PUSCH transmission
   MsgA-PUSCH-TimeDomainAllocation, the index to indicates a combination of start symbol and length and PUSCH mapping type
   The index gives valid combinations of start symbol, length and mapping type as start and length indicator (SLIV) for the first msgA PUSCH occasion, e.g. startSymbolAndLengthMsgA-PO
   Number of PRBs per PUSCH occasion, e.g. nrofPRBs-PerMsgA-PO
   The data scrambling (c_init) for msgA PUSCH transmission
   Power offset of msgA PUSCH relative to the preamble received target power
   Indication whether transform precoder for MsgA transmission is enabled or disabled
   Number of time domain PUSCH occasions in each slot, e.g. nrofMsgA-PO-PerSlot
   PRB-level guard band between FDMed PUSCH occasions
   Guard period between PUSCH occasions in the unit of symbols
   Interlace index of the first PUSCH occasion in frequency domain. This parameter is optionally included if interlaced PUSCH is configured
   PUSCH mapping type, e.g. type A or type B
   Dedicated alpha value for MsgA PUSCH
   Value of hopping bits, which is used to indicate which frequency offset to be used for second hop
   Indication to indicate whether intra-slot frequency hopping per PUSCH occasion
   Time offset with respect to the start of each PRACH slot
   Number of DMRS sequences for MsgA PUSCH for CP-OFDM
   Number of consecutive interlaces per PUSCH occasion. This parameter is optionally included if interlaced PUSCH is configured
   Number of slots (in active UL BWP numerology) containing one or multiple PUSCH occasions, e.g. nrofSlotsMsgA-PUSCH
   MsgA-DMRS-AdditionalPosition indication, which indicates the position for additional DM-RS. If the field is absent, the UE applies value pos2
   MsgA-MaxLength, which indicates single-symbol or double-symbol DMRS is used for MsgA PUSCH transmission
   Indication of indices of CDM group(s) used
   Indication to indicate the number of port per CDM group of the PUSCH resource used, e.g. msgA-PUSCH-NrofPort,
   The UL DMRS scrambling initialization for CP-OFDM,
   PUSCH group information, e.g. group A or group B.

The size of padding bits used in the MsgA PUSCH payload transmission.

The size of MsgA PUSCH payload transmitted without the padding bits.

The size of PO used for MsgA PUSCH payload transmission.

The power used for MsgA PUSCH transmission.

The power ramping step used.

The power offset used for preamble group selection for 2 step RA.

The power offset used for preamble group selection for 4 step RA.

The threshold to determine the groups of Random Access Preambles for 2-step RA type.
The threshold to determine the groups of Random Access Preambles for 4-step RA type.
A RA resource configuration information.
A UE status (e.g. In-Device Coexistence detected, overheating, RRM relaxation).
A slice ID, if the RA resource is slice-specific.

The indication of whether multiple RA resource types are configured (e.g. multiRATypeConfigured) can be implemented as below:

Alternative 1: One bit indication. The indication is set to “0” if only one type of RA resource is configured; and set to “1” when more than one type of RA resource is configured. Or vice versa.

Alternative 2: Presence/Absence. A presence of the indication can indicate that more than one type of RA resource is configured. An absence of the indication means that only one type of RA resource (e.g. either 4-step or 2-step RA resource) is configured.

The indication of whether multiple RA resource types are configured can be on the basis of per selected bandwidth part (BWP), per selected uplink carrier or per selected cell.

The indication of whether maximum number of MsgA transmission is reached or exceeded (e.g. MsgA-TransMaxReached, MsgA-TransMaxExceeded) can be implemented as follows:

Alternative 1: One bit indication. The indication is set to “1” if the number of MsgA transmission is >= (larger or equal) or > (larger) than the maximum number of MsgA transmission allowed in an usual or regular RA procedure; the indication is set to “0” when the number of MsgA transmission is < (smaller) or <= (smaller or equal) than the maximum number of MsgA transmission allowed in a usual RA procedure. Or vice versa. This indication may be used when the maximum number of MsgA transmission allowed in a RA procedure is configured and the 2-step RA resource has been used in the RA procedure, otherwise this indication is absence.

Alternative 2: Presence/Absence. A presence of the indication can indicate that the number of MsgA transmission is >= (larger or equal) or > (larger) than the maximum number of MsgA transmission allowed in a RA procedure. An absence of the indication means that the number of MsgA transmission is < (smaller) or <= (smaller or equal) than the maximum number of MsgA transmission allowed in a RA procedure.

This indication can be set per RA attempt or per RA procedure.

The indication of whether the strength or quality of downlink pathloss reference is > (higher) or >= (higher or equal) than the threshold configured for a selected RA type (a/k/a RA type selection) can be implemented as follow:

One bit indication. The indication is set to “1” if the strength or quality of selected beam is > (higher) or >= (higher or equal) than the configured threshold for RA type selection, otherwise set to “0”. Or vice versa.

In some examples, the indication is used when the threshold configured for RA type selection has been configured, otherwise the indication is absence.

This indication can be set per RA attempt or per RA procedure. In some example, this indicator is optionally presented only when UE fallback to 4-step RA occurs. The fallback can occur after reception of a fallback indication from network. In some example, if fallback indication is introduced, then the indication relating to the strength or quality of downlink pathloss reference is optionally included when the fallback indication indicates a fallback has occurred for this RA attempt or for this RA procedure. In another example, this indication is optionally presented when the strength or quality of selected beam is not above the threshold configured for beam selection, e.g. the dlRSRPAboveThreshold is set to false, otherwise this indication is absent.

In another example, instead of the strength or quality of downlink pathloss reference, this indication is used to indicate whether the strength or quality of selected beam is > (higher) or >= (higher or equal) than the threshold configured for RA type selection.

The indication of whether MsgA PUSCH payload is transmitted for this 2 step RA attempt can be implemented as below:

One bit indication, it is set to “1” if the MsgA PUSCH is transmitted for this 2 step RA attempt, otherwise set to “0”. Or vice versa.

In some examples, the indication is used when the threshold configured for RA type selection has been configured, otherwise the indication is absence.

In some examples, this indicator is optionally included only when UE fallback to 4 step RA, e.g. after reception of fallback indication from network. In some examples, if fallback indication is introduced, then this indication is optionally included when the fallback indication indicates a fallback is occurred for this RA attempt or for this RA procedure.

The PUSCH configuration information can be implemented as below:

UE will include the PUSCH configuration information of the PUSCH resource used in the RA procedure. The PUSCH configuration information includes PUSCH group information. For example, different information elements can be used to indicate the usage of different PUSCH groups, e.g. group A, group B, etc. As a result, the NW can determine which PUSCH group is used for the RA procedure based on the name of the information element. The PUSCH group information can be set per RA procedure or per RA attempt.

The RA resource configuration information can be implemented as below:

Different information elements can be used to express the configuration of different types of RA resource. In some examples, a 2-step RA resource-specific information element can be used to express the separated RA resource configuration for 2-step RA. If 2 step RA resource is separately configured, then the 2-step RA resource configuration will use this 2-step RA resource-specific information element. However, if the resource (e.g., RO) is shared between 2-step RA and 4-step RA, the 2-step RA resource configuration use the same information element as used to express the 4-step RA resource configuration.

Step 2: The network may perform e.g. RACH optimization according to the RA information. For example, according to the indication of whether maximum number of MsgA transmission is reached or exceeded, the network may update the configuration of the Maximum number of MsgA transmission allowed in a RA procedure associated with the UE to improve the success rate of subsequent or future RA procedures. Thus, the network may perform RACH optimization by collecting RA information received in messages from one or more wireless nodes, and then perform statistical analysis on the collected RA information.

### Example Embodiment 2 (RA Information)

FIG. 2 is a signaling process for this example embodiment.

Step 1: A UE sends a RA information to a network node.

The RA information includes one or more RA information entry, where each RA information entry includes information of a successful or unsuccessful RA procedure.

Each RA information entry includes at least one of the parameters included in the RA information in the Example Embodiment 1.

Step 2: The network may perform e.g. RACH (Random Access Channel) optimization according to the RA information from the UE.

### Example Embodiment 3 (RA Information)

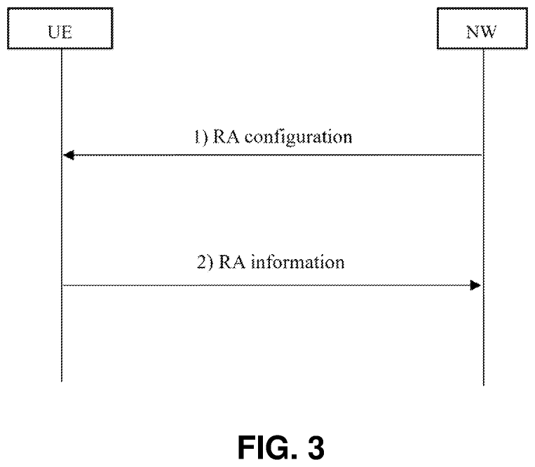

FIG. 3 is a signaling process for this example embodiment.

Step 1: A network sends a RA configuration to a UE. The RA configuration can be delivered to the UE via system information broadcast or RRC signaling.

The RA configuration includes at least one of:
A period of time, which if configured, then the UE only reports the RA information of RA procedure within the period of time from a time point of receiving the RA configuration.
A length of time, which, if configured, then the UE only reports the RA information of RA procedure when the time the RA procedure used is >= (larger or equal) or > (larger) or < (smaller) or <= (smaller or equal) than the length of time.
A list of Cell ID, if configured UE only reports the RA information of the cell with Cell ID belonging to the list of Cell ID.
A list of PLMN IDs if configured UE only reports the RA information when the RPLMN (or serving PLMN) belonging to the list of PLMN ID. Or in some example, when the RPLMN (or serving PLMN) or EPLMN belonging to the list of PLMN ID.
A list of indices associated with location areas, where each index is associated to a certain location area. If configured, UE only reports the RA information when locates within the area associated to the index included in the list of indices.
A list of TAC (Tracking Area Code)+Cell ID, if configured UE only reports the RA information when the TAC+Cell ID belonging to the list of TAC+Cell ID.
A list of frequencies.
One or more UE categories. If configured, only the UEs belonging to the UE categories specified in the RA configuration will report the RA information to the network node.
One or more access categories. If configured, only the UEs associated with the access categories specified in the RA configuration will report the RA information to the network node.
One or more Network types. If configured, only the UEs connected to networks of the type(s) specified in the RA configuration will report the RA information to the network node. The Network type can be a terrestrial network, non-terrestrial network (NTN), public network, non-public network (NPN), UTRA, EUTRA or NR. Furthermore, in some examples, the NTN Network type can be further specified as GEO, LEO, HAPS, etc.
A list of NPN identities. If configured UE reports the RA information when using the NPN network with NPN identity belongs to the list of NPN identities.
A threshold for a ratio of RA attempt whose RSRP is lower than the configured beam selection threshold. The ratio can be obtained as the number of RA attempts with RSRP lower than the configured beam selection threshold divided by the total number of RA attempts of the RA procedure. If configured, a UE only reports the RA information of a RA procedure if the ratio of RA attempt whose RSRP is lower than the configured beam selection threshold is above this threshold. In other examples, if configured UE only reports the RA information of RA procedure when ratio of RA attempt whose RSRP is lower than the configured beam selection threshold is below the configured threshold. In some implementations, the beam selection threshold can be replaced by other threshold defined for RA procedure, for example, the threshold defined for RA type selection.
A list of Slice IDs, if configured UE only reports the RA information of RA procedure when the used RA resource is associated to a slice ID belonging to the list of Slice ID.
An indication associated to slice, if configured UE only reports the RA information of RA procedure when the used RA resource is slice specific.
A UE status (e.g. In-Device Coexistence detected, overheating, RRM relaxation). For example, if configured UE only reports the RA information of RA procedure when in a RRM relaxation status.

The RA configuration parameters can be used independently or in a combination. If used in a combination, the UE may report the RA information when all of the conditions are satisfied or when at least one of the conditions are satisfied. In some implementations, how to apply each parameter in the combination can be specified or defined.

Step 2: The UE reports the RA information to the network according to the RA configuration.

### System Implementations

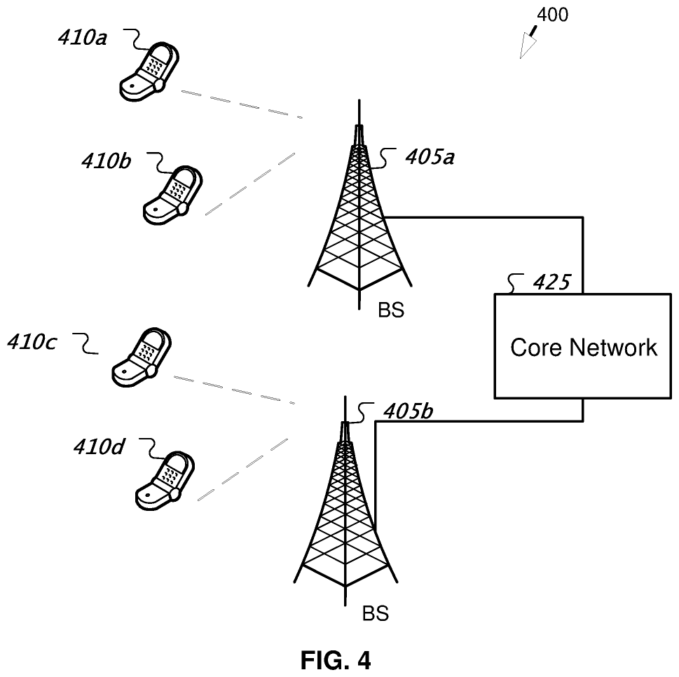

FIG. 4 shows an example of a wireless communication system where techniques in accordance with one or more embodiments of the present technology can be applied. A wireless communication system 400 can include one or more base stations (BSs) 405a, 405b, one or more wireless devices 410a, 410b, 410c, 410d, and a core network 425. A base station 405a, 405b can provide wireless service to wireless devices 410a, 410b, 410c and 410d in one or more wireless sectors. In some implementations, a base station 405a, 405b includes directional antennas to produce two or more directional beams to provide wireless coverage in different sectors.

The core network 425 can communicate with one or more base stations 405a, 405b. The core network 425 provides connectivity with other wireless communication systems and wired communication systems. The core network may include one or more service subscription databases to store information related to the subscribed wireless devices 410a, 410b, 410c, and 410d. A first base station 405a can provide wireless service based on a first radio access technology, whereas a second base station 405b can provide wireless service based on a second radio access technology. The base stations 405a and 405b may be co-located or may be separately installed in the field according to the deployment scenario. The wireless devices 410a, 410b, 410c, and 410d can support multiple different radio access technologies. In some embodiments, the base stations 405a, 405b may be configured to implement some techniques described in the present document. The wireless devices 410a to 410d may be configured to implement some techniques described in the present document.

In some implementations, a wireless communication system can include multiple networks using different wireless technologies. A dual-mode or multi-mode wireless device includes two or more wireless technologies that could be used to connect to different wireless networks.

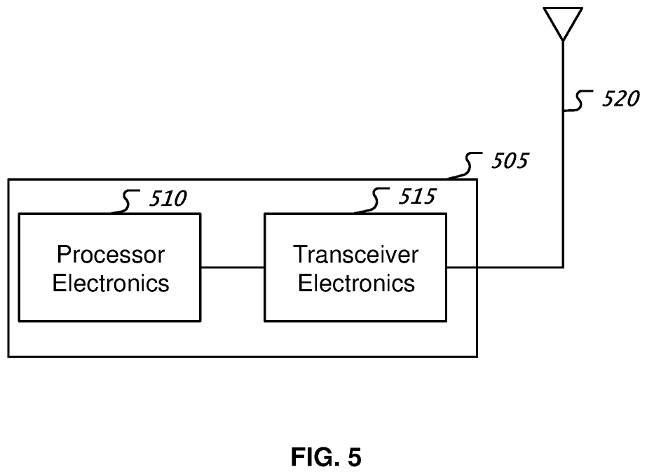

FIG. 5 is a block diagram representation of a portion of a hardware platform. A hardware platform 505 such as a network node or a base station or a wireless device (or UE) can include processor electronics 510 such as a microprocessor that implements one or more of the techniques presented in this document. The hardware platform 505 can include transceiver electronics 515 to send and/or receive wired or wireless signals over one or more communication interfaces such as antenna 520 or a wireline interface. The hardware platform 505 can implement other communication interfaces with defined protocols for transmitting and receiving data. The hardware platform 505 can include one or more memories (not explicitly shown) configured to store information such as data and/or instructions. In some implementations, the processor electronics 510 can include at least a portion of the transceiver electronics 515. In some embodiments, at least some of the disclosed techniques, modules or functions, a central node, a distributed node, a terminal or network nodes are implemented using the hardware platform 505.

Some embodiments of the disclosed technology are presented in clause-based format.

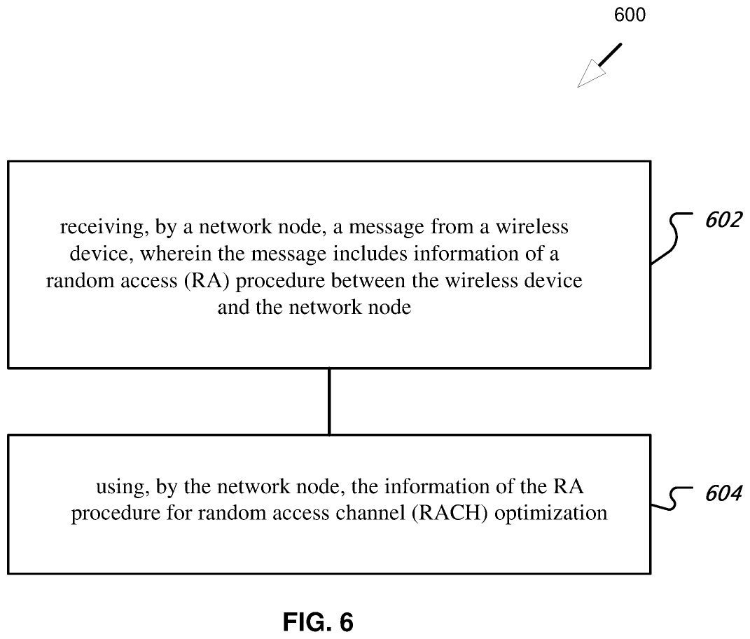

1. A method (e.g., method 600 depicted in FIG. 6 in connection with embodiment 1 discussed herein) of wireless communication, comprising:

receiving (602), by a network node, a message from a wireless device, wherein the message includes information of a random access (RA) procedure between the wireless device and the network node; and

using (604), by the network node, the information of the RA procedure for random access channel (RACH) optimization.

2. The method of clause 1, wherein the RA procedure associated with the wireless device comprises multiple RA attempts to establish a communication session, and wherein the RA procedure corresponds to a successful RA procedure in a case that a final one of the RA attempts is successful.

3. The method of clause 1, wherein the RA procedure associated with the wireless device comprises multiple RA attempts to establish a communication session, and wherein the RA procedure corresponds to an unsuccessful RA procedure in a case that every one of RA attempts associated with the wireless device is unsuccessful.

4. The method of any one or more of clauses 1-3, wherein the information of the RA procedure includes at least one information element (IE) related to: a maximum number of message A transmissions allowed in a 2-step RA procedure, an indication of whether the maximum number of message A transmissions allowed in a 2-step RA procedure is reached or exceeded, a threshold for uplink carrier selection, an indication of whether a strength or quality of a selected beam is one of: higher, higher or equal, lower, or lower or equal than the threshold for uplink carrier selection, an indication of whether a strength or quality of downlink pathloss reference is one of: higher, or higher or equal than a threshold for selection of a type of RA procedure, an indication of whether a message A Physical Uplink Shared Channel (PUSCH) payload is transmitted for a 2-step RA procedure, an indication of whether an entirety of a rach occasion (RO) resource is applicable for a 2-step RA procedure when the RO resource is shared between a 4-step RA procedure and a 2-step RA procedure, an indication of whether a message B is received or not, a PUSCH configuration information, a RA resource configuration information, a status of the wireless device, or a slice ID associated with a slice-specific resource.

5. The method of clause 4, wherein the status of the wireless device includes an in-device coexistence detected status, an overheating status, or a radio resource management (RRM) relaxation status.

6. The method of clause 4, wherein the at least one IE is selectively included in, or excluded from, the information of a RA procedure depending on whether the at least one IE meets a specified condition.

7. The method of clause 1, wherein the RACH optimization is performed by the network node based on a statistical analysis performed on information of RA procedures included in a plurality of messages from one or more wireless devices.

8. The method of clause 6, wherein the specified condition relates to a number of message A transmissions in a 2-step RA procedure, and wherein, the at least one IE takes a first value in a case that the number of message A transmissions in the 2-step RA procedure is larger than or equal to a maximum number of message A transmissions allowed in an usual 2-step RA procedure, and a second value otherwise.

9. The method of clause 6, wherein the specified condition relates to a number of message A transmissions in a 2-step RA procedure, and wherein, a presence of the at least one IE in the information of the RA procedure represents that the number of message A transmissions in the 2-step RA procedure is larger than or equal to a maximum number of message A transmissions allowed in an usual 2-step RA procedure.

10. The method of clause 6, wherein the specified condition relates to a number of message A transmissions in a 2-step RA procedure, and wherein, an absence of the at least one IE represents that the number of message A transmissions in the 2-step RA procedure is smaller than or equal to a maximum number of message A transmissions allowed in an usual 2-step RA procedure.

11. The method of clause 6, wherein the specified condition relates to a strength or quality of a downlink pathloss reference of a selected beam, and wherein, the at least IE included in the information of the RA procedure takes a first value in a case that the strength or quality of a downlink pathloss reference signal of the selected beam is larger, or larger or equal than a threshold configured by the network node for a RA type, and a second value otherwise.

12. The method of clause 11, wherein, a presence of the at least one IE represents that the threshold for the RA type is configured by the network.

13. The method of any one or more of clauses 11-12, wherein the at least one IE is set according to a per RA attempt basis or a per RA procedure basis.

14. The method of any one or more of clauses 11-12, wherein the presence of the at least one IE indicates an occurrence of fallback of the RA procedure to a 4-step RA procedure.

15. The method of clause 14, wherein the occurrence of the fallback of the RA procedure to the 4-step RA procedure is subsequent to the network node sending a fallback indication to the wireless device.

16. The method of clause 6, wherein the specified condition relates to transmission of a message A Physical Uplink Shared Channel (PUSCH) payload for a 2-step RA procedure, and wherein, the at least one IE included in the information of the RA procedure takes a first value in a case that the message A PUSCH payload is transmitted, and a second value otherwise.

17. The method of clause 16, wherein a presence of the at least one IE indicates an occurrence of fallback of the RA procedure to a 4-step RA procedure.

18. The method of clause 17, wherein the occurrence of the fallback of the RA procedure to the 4-step RA procedure is subsequent to the network node sending a fallback indication to the wireless device.

19. The method of clause 6, wherein the specified condition relates to PUSCH configuration information of PUSCH groups, and wherein, the at least one IE included in the information of the RA procedure takes a first value in a case that a first PUSCH group is used, and a second value in a case that a second PUSCH group different from the first PUSCH group is used.

20. The method of clause 6, wherein the specified condition relates to a resource separately configured for a 2-step RA procedure and a 4-step RA procedure, and wherein, the at least one IE of the information of the RA procedure take a first value in a case that the resource is separately configured, and a second value otherwise.

21. The method of clause 20, wherein the second value corresponds to a case that the resource is shared between the 4-step RA procedure and the 2-step RA procedure.

22. The method of clause 21, wherein the resource is a rach occasion (RO) resource, and the first value is a resource-specific information element.

23. The method of clause 1-22, wherein the at least one IE is an optional information element that is selectively included in, or excluded from, the information of the RA procedure.

24. The method of any one or more of clauses 1-23, wherein the RA procedure corresponds to at least one of: a contention based random access procedure (CBRA) or a contention free random access procedure (CFRA).

25. The method of any one or more of clauses 1-24, wherein the RA procedure corresponds to at least one of: a 4-step RA procedure or a 2-step RA procedure.

The full names of several acronyms used in this document are provided below.

| Acronym | Full Name |
|---|---|
| 5G | Fifth Generation |
| 5GC | 5G Core network |
| AMF | Access Mobility Function |
| SMF | Session Management Function |
| UPF | User Plane Function |
| CN | Core Network |
| 5QI | 5G QoS Identifier |
| QoS | Quality of Service |
| EPC | Evolved Packet Core |
| LTE | Long Term Evolution |
| NR | New Radio |
| CU | Centralized Unit |
| DU | Distributed Unit |
| CP | Control Plane |
| UP | User Plane |
| BSR | Buffer Status Report |
| PHR | Power Headroom Report |
| SDAP | Service Data Adaptation Protocol |
| PDCP | Packet Data Convergence Protocol |
| RLC | Radio Link Control |
| MAC | Medium Access Control |
| PDU session | Protocol Data Unit session |
| DRB | Data Radio Bearer |
| SRB | Signaling Radio Bearer |
| GBR | Guaranteed Bit Rate |
| AMBR | Aggregated Maximum Bit Rate |
| RRM | Radio Resource Management |
| Uu | User-to-user |
| RNA | RAN Notification Area |
| RAN | Radio Access Network |
| MN | Master node |
| SN | Secondary node |
| PCell | Primary Cell |
| SCell | Secondary Cell |
| PSCell | Primary SCG Cell |
| MCG | Master Cell Group |
| SCG | Secondary Cell Group |
| OAM | Operation Administration and Maintenance |
| TCE | Trace Collection Entity |
| MDT | Minimization of Driving Test |
| SI | System Information |
| NGAP | Next Generation Application Protocol |
| RA | Random Access |
| RACH | Random Access Channel |
| RRC | Radio Resource Control |
| DAPS | Dual Active Protocol Stack |

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

From the foregoing, it will be appreciated that specific embodiments of the presently disclosed technology have been described herein for purposes of illustration, but that various modifications may be made without deviating from the scope of the invention. Accordingly, the presently disclosed technology is not limited except as by the appended claims.

I/We claim:

1. A method of wireless communication, comprising:
receiving, by a network node, a message from a wireless device, wherein the message comprises information of a random access (RA) procedure between the wireless device and the network node; and
using, by the network node, the information of the RA procedure for random access channel (RACH) optimization;
wherein, the information of a random access (RA) procedure comprises at least one information element (IE) related to: a maximum number of message A transmissions allowed in a 2-step RA procedure, PUSCH configuration information used during the RA procedure, a threshold for uplink carrier selection, an indication of whether a strength or quality of a selected beam is one of: higher, higher or equal, lower, or lower or equal than the threshold for uplink carrier selection, an indication of whether a message A Physical Uplink Shared Channel (PUSCH) payload is transmitted for a 2-step RA procedure, an indication of whether an entirety of a RACH occasion (RO) resource is applicable for a 2-step RA procedure when the RO resource is shared between a 4-step RA procedure and a 2-step RA procedure, an indication of whether a message B is received or not, a PUSCH configuration information, a status of the wireless device, or a slice ID associated with a slice-specific resource.

2. The method of claim 1, wherein the RA procedure associated with the wireless device comprises multiple RA attempts to establish a communication session, and wherein the RA procedure corresponds to a successful RA procedure in a case that a final one of the RA attempts is successful.

3. The method of claim 1, wherein the RA procedure associated with the wireless device comprises multiple RA attempts to establish a communication session, and wherein the RA procedure corresponds to an unsuccessful RA procedure in a case that every one of RA attempts associated with the wireless device is unsuccessful.

4. The method of claim 1, wherein the PUSCH configuration information used during the RA procedure comprises at least one of:
modulation and coding scheme (MCS) index for MsgA PUSCH payload transmission,
index used to indicate a combination of a start symbol and a length and a PUSCH mapping type,
a number of MsgA PUSCH occasions that are frequency-division multiplexed in one time instance,
an offset of a lowest PUSCH timing in frequency domain relative to a start physical resource block (PRB 0),
subcarrier spacing (SCS) of PUSCH resources used for MsgA PUSCH payload transmission,
the number of PRBs per PUSCH occasion, or
PUSCH group information.

5. The method of claim 1, wherein the status of the wireless device includes an in-device coexistence detected status, an overheating status, or a radio resource management (RRM) relaxation status.

6. The method of claim 1, wherein the at least one IE is selectively included in, or excluded from, the information of a RA procedure depending on whether the at least one IE meets a specified condition.

7. The method of claim 1, wherein the RACH optimization is performed by the network node based on a statistical analysis performed on information of RA procedures included in a plurality of messages from one or more wireless devices.

8. The method of claim 6, wherein the specified condition relates to transmission of a message A Physical Uplink Shared Channel (PUSCH) payload for a 2-step RA procedure, and wherein, the at least one IE included in the information of the RA procedure takes a first value in a case that the message A PUSCH payload is transmitted, and a second value otherwise.

9. The method of claim 6, wherein the specified condition relates to PUSCH configuration information of PUSCH groups, and wherein, the at least one IE included in the information of the RA procedure takes a first value in a case that a first PUSCH group is used, and a second value in a case that a second PUSCH group different from the first PUSCH group is used.

10. The method of claim 6, wherein the specified condition relates to a resource separately configured for a 2-step RA procedure and a 4-step RA procedure, and wherein, the at least one IE of the information of the RA procedure take a first value in a case that the resource is separately configured, and a second value otherwise.

11. The method of claim 10, wherein the second value corresponds to a case that the resource is shared between the 4-step RA procedure and the 2-step RA procedure.

12. The method of claim 11, wherein the resource is a rach occasion (RO) resource, and the first value is a resource-specific information element.

13. The method of claim 1, wherein the at least one IE is an optional information element that is selectively included in, or excluded from, the information of the RA procedure.

14. The method of claim 1, wherein the RA procedure corresponds to at least one of: a contention based random access procedure (CBRA) or a contention free random access procedure (CFRA).

15. The method of claim 1, wherein the RA procedure corresponds to at least one of: a 4-step RA procedure or a 2-step RA procedure.

16. An apparatus comprising a processor configured to perform a method comprising:
receiving, by a network node, a message from a wireless device, wherein the message comprises information of a random access (RA) procedure between the wireless device and the network node; and
using, by the network node, the information of the RA procedure for random access channel (RACH) optimization;
wherein, the information of a random access (RA) procedure comprises at least one information element (IE) related to: a maximum number of message A transmissions allowed in a 2-step RA procedure, PUSCH configuration information used during the RA procedure, a threshold for uplink carrier selection, an indication of whether a strength or quality of a selected beam is one of: higher, higher or equal, lower, or lower or equal than the threshold for uplink carrier selection, an indication of whether a message A Physical Uplink Shared Channel (PUSCH) payload is transmitted for a 2-step RA procedure, an indication of whether an entirety of a RACH occasion (RO) resource is applicable for a 2-step RA procedure when the RO resource is shared between a 4-step RA procedure and a 2-step RA procedure, an indication of whether a message B is received or not, a PUSCH configuration information, a status of the wireless device, or a slice ID associated with a slice-specific resource.

17. The apparatus of claim 16, wherein the RA procedure associated with the wireless device comprises multiple RA attempts to establish a communication session, and wherein the RA procedure corresponds to a successful RA procedure in a case that a final one of the RA attempts is successful.

18. The apparatus of claim 16, wherein the RA procedure associated with the wireless device comprises multiple RA attempts to establish a communication session, and wherein the RA procedure corresponds to an unsuccessful RA procedure in a case that every one of RA attempts associated with the wireless device is unsuccessful.

19. The apparatus of claim 16, wherein the PUSCH configuration information used during the RA procedure comprises at least one of:
modulation and coding scheme (MCS) index for MsgA PUSCH payload transmission,
index used to indicate a combination of a start symbol and a length and a PUSCH mapping type,
a number of MsgA PUSCH occasions that are frequency-division multiplexed in one time instance,
an offset of a lowest PUSCH timing in frequency domain relative to a start physical resource block (PRB 0),
subcarrier spacing (SCS) of PUSCH resources used for MsgA PUSCH payload transmission,
the number of PRBs per PUSCH occasion, or
PUSCH group information.

20. The apparatus of claim 16, wherein the status of the wireless device includes an in-device coexistence detected status, an overheating status, or a radio resource management (RRM) relaxation status.
